(19) United States
(12) Patent Application Publication
(10) Pub. No.: US 2014/0084548 A1
(43) Pub. Date: Mar. 27, 2014

(54) SEAL

(71) Applicant: Ameritek International Inc., Eagan, MN (US)

(72) Inventor: Donovan Kostron, Woodbury, MN (US)

(73) Assignee: Ameritek International Inc., Eagan, MN (US)

(21) Appl. No.: 14/033,750

(22) Filed: Sep. 23, 2013

Related U.S. Application Data
(60) Provisional application No. 61/703,904, filed on Sep. 21, 2012.

(51) Int. Cl. F16J 15/34

(52) U.S. Cl. CPC F16J 15/34
USPC 277/500

(57) ABSTRACT

A seal may be provided for sealing around a shaft passing through an opening in a housing and into a chamber within the housing and the seal may include a shaft engaging portion, a housing engaging portion, and a sealing core arranged between the housing engaging portion and the shaft engaging portion and the sealing core may include a plurality of radially outward extending sealing projections configured to sealingly and slidingly engage the housing engaging portion.

### FIELD OF THE INVENTION

The present application relates to maintaining separation between debris and lubrication chambers where rotating shafts enter such chambers. More particularly, the present application relates to seals for sealing around rotating shafts entering lubrication chambers. Still more particularly, the present application relates to seals for sealing around rotating shafts to keep lubrication contained around a bearing, for example, and for resisting entry of dirt or debris into the chamber where the bearing resides. Still more particularly, the present application relates to seals for sealing shafts used with agricultural furrow opening discs, for example.

### BACKGROUND

Agricultural plowing often involves dragging relatively thin discs behind a tractor, for example. Several of these discs are often supported on a shaft such that the discs may rotate together with or relative to the shaft. The discs may be isolated rotationally from the shaft via a bearing that is lubricated to reduce friction and prolong the life of the bearing. A seal may be used to seal around the shaft, maintain the lubrication around the bearing, and prevent dirt or other debris from accessing the bearing. In this agricultural environment, there is often dirt and wrappage including debris, such as former plants, stalks, leaves, garbage, plastics, and other wrappage that may become wrapped tightly around the shaft and may be forcibly urged against the seal. Some existing seals include a face plate isolated from other parts of the seal with elastomeric lips. The wrappage described may work its way between the face plate and the other parts of the seal causing damage and creating a pathway for dirt or other contaminates to enter the lubrication chamber.

### SUMMARY

In one embodiment, the present application includes a face plate free seal particularly adapted for the above-described agricultural environment. While the seal may be used in a variety of contexts and applications, the seal, in this embodiment, may be particularly suited to avoid interference by wrappage. The seal, in this embodiment, may be adapted for sealing around a shaft passing through an opening in a housing and into a chamber within the housing. The seal may include a shaft engaging portion, a housing engaging portion, and a sealing core arranged between the housing engaging portion and the shaft engaging portion. The sealing core may include a plurality of radially outward extending sealing projections configured to sealingly and slidingly engage the housing engaging portion.

In another embodiment, a seal for sealing around a shaft passing through an opening in a housing and into a chamber within the housing may be provided. The seal may include a shaft engaging portion including a shaft surrounding element and a radially extending flange having a radially outward tip. The radially extending flange may include a covering extending radially beyond the radially outward tip of the flange to form a flap configured to engage the housing. The seal may also include a sealing core sleevingly arranged about the shaft engaging portion and comprising a plurality of radially outward extending sealing projections. The seal may include a housing engaging portion including a boundary element and an inside plate extending radially inward from the boundary element. The plurality of radially outward extending sealing projections may sealingly engage the boundary element and the flap may function to resist entry of wrappage behind the radially extending flange.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed description is to be regarded as illustrative in nature and not restrictive.

### BRIEF DESCRIPTION OF THE FIGURES

FIG. 1 is a perspective view of a seal in place on a shaft together with an agricultural disc, according to some embodiments.

FIG. 2 is a cross-sectional view of a portion of the seal of FIG. 1.

FIG. 3 is a cross-sectional view of a portion of a seal according to another embodiment.

### DETAILED DESCRIPTION

The present application, in some embodiments, is directed toward a seal for isolating bearing assemblies for agricultural discs from the surrounding environment. The seal may be particularly adapted to avoid interference by wrappage and, in particular, may be free of a faceplate. The seal may be placed over a shaft and into a surrounding housing to maintain lubrication in and keep debris out. As such, the lubrication may remain within the housing such that the lubrication can lubricate the bearing and the lubrication may last longer due to the limited entry of debris or dirt that may break down the lubrication and/or wear out the bearing.

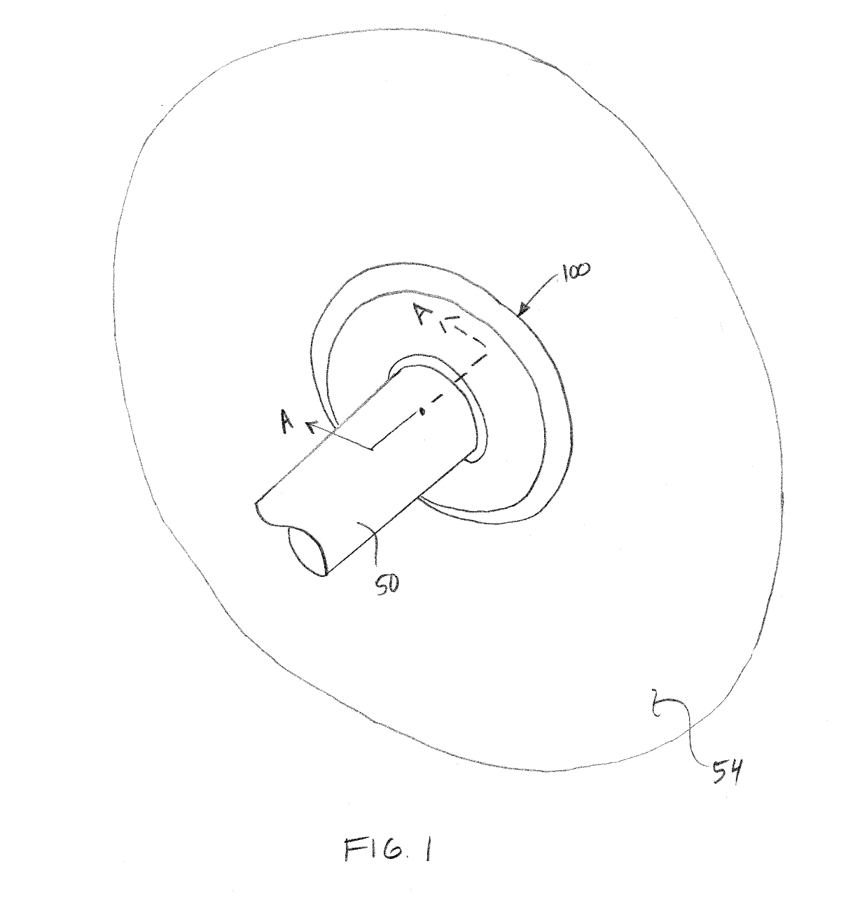

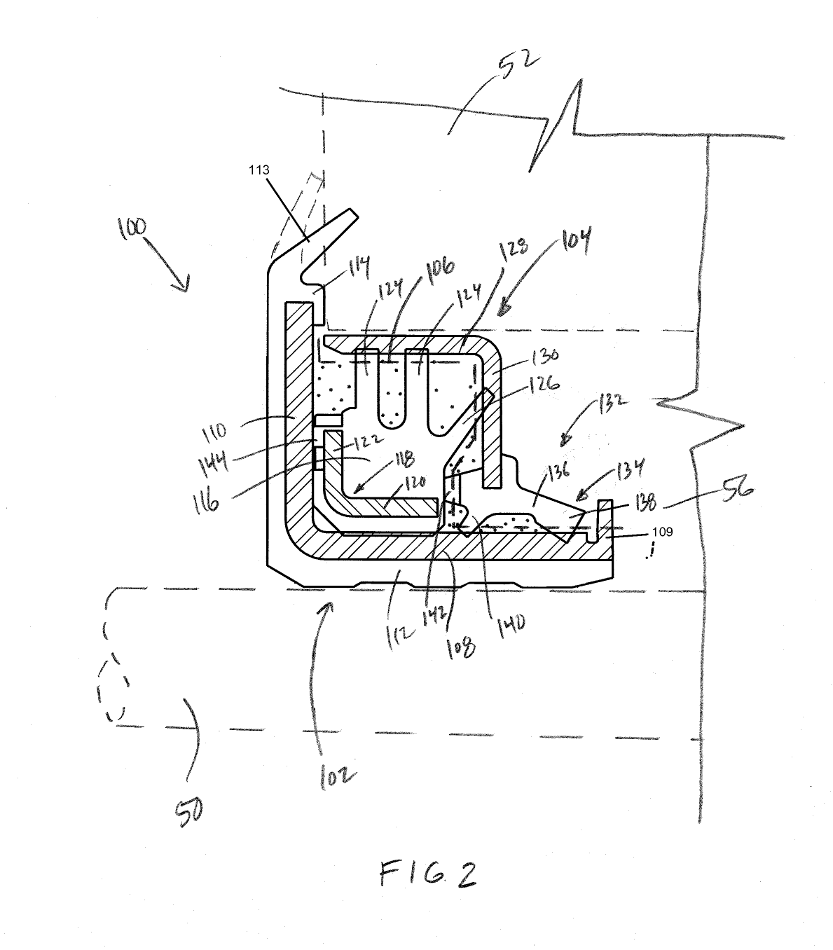

Referring now to FIG. 1, a seal 100 is shown in place on a shaft 50 and within a housing portion 52 of an agricultural disc 54. With further reference to FIG. 2, which shows cross-section A-A of FIG. 1, the seal 100 may function to isolate the bearing chamber 56 of the disc 54 from the environment by closing off the bearing chamber 56 or other lubrication chamber from the environment. The seal 100 may include a shaft engaging portion 102 configured to rotationally engage the shaft 50 and a housing engaging portion 104 configured to rotationally engage the housing 52. Each portion of the seal 100 may be arranged on opposing sides of a slip line 106 extending through the seal 100. The seal 100 may include one or more sealing elements extending toward the slip line 106 and engaging the opposing portion of the seal 100 at and/or along the slip line 106. Accordingly, the shaft engaging portion 102 and the housing engaging portion 104 may slippingly engage one another at the slip line 106 and function to reduce or minimize the release of lubrication from the lubrication chamber 56 and the entry of dirt or debris into the lubrication chamber 56 while also rotating relative to one another.

With continued reference to FIG. 2, a cross-section A-A as depicted on FIG. 1 is shown. The cross-section is taken through the seal 100 and the cross-sectional shape and arrangement of the seal 100 may be substantially continuous around the shaft 50 such that each shape shown in cross-section is a substantially annularly extruded shape about the shaft 50. The several parts and pieces of the seal 100 may be described based on the shapes and relationships shown in the cross-sectional figure. Still further the terms axially and radially may be used to describe orientations and directions regarding the seal. The term axially generally refers to the longitudinal direction of the shaft such that axially inward means along the shaft 50 and toward the chamber 56 while axially outward means along the shaft 50 and away from the chamber 56. The term radially generally refers to the directions radiating from the center point of the shaft 50 such that radially outward means tending away from the longitudinal axis of the shaft while radially inward means tending toward the longitudinal axis of the shaft.

As shown in FIG. 2, the shaft engaging portion 102 may include a shaft surrounding element 108 and a radially extending flange 110. As shown, the cross-sectional shape of the shaft surrounding element 108 may be generally plate like extending generally parallel to the shaft 50 with a substantially constant thickness. The shaft surrounding element 108 may be generally cylindrically shaped with a diameter slightly greater than the outer diameter of the shaft 50 allowing for an elastomeric material to be arranged on a radially inner surface of the shaft surrounding element 108. The shaft surrounding element 108 may include an axial inner edge and an axial outer edge. In some embodiments, the shaft surrounding element 108 may include a keeper lip or flange 109 extending radially outward from the axial inner edge of the shaft surrounding element 108. The keeper lip or flange 109 may extend generally perpendicularly to the shaft 50. The keeper lip or flange 109 may function to reduce or prevent excessive axial propagation of the housing engaging portion 104 relative to the shaft engaging portion 102. In some embodiments, the presence of the keeper lip or flange 109 may create a unitized or cartridge-type seal where the two major portions (housing engaging portion 104/shaft engaging portion 102) may be prevented from coming apart or fully separating. In still other embodiments, the keeper lip or flange 109 may be omitted.

The radially extending flange 110 may extend radially away from the axial outer edge of the shaft surrounding element 108 and may extend generally perpendicularly relative to the shaft surrounding element 108 and generally away from the shaft 50. The radially extending flange 110 may have a cross-sectional length selected to extend slightly beyond the opening in the housing 52 such that the radial outer edge of flange 110 may extend beyond the opening allowing an inner face of the flange 110 at the outer edge to seat against the housing 52 and prevent inward propagation of the seal 100.

The shaft surrounding element 108 and the radially extending flange 110 may include an elastomeric covering 112. The covering 112 may extend along an inner surface of the shaft surrounding element 108 and may be configured to frictionally engage the shaft 50 such that relative radial motion of the shaft surrounding element 108 and the shaft 50 is resisted and/or prevented. The covering 112 may also extend radially outward along the axially outward face of the radially extending flange 110. The cover 112 may extend beyond the radially outward tip of the flange 110 forming a flap 113 that may extend partially axially inward therefrom so as to engage the face of the housing 52 as shown. The flap 113 may have a position as shown in solid lines before installation and may have a position as shown in dashed lines when installed and, as such, may be biased against the housing 52 in the installed condition due to be slightly deformed from its natural position. The covering 112 may include a wraparound portion 114 wrapping around the end of the radially extending flange 110 allowing for the flange 110 to sealingly seat against an outer surface of the housing 52 and preventing overly stressing the flap 113 when the seal 100 is installed.

The shaft engaging portion 108 may also include a seal core 116 or, as shown, a reinforced seal core 116. The seal core 116 may be made from an elastomeric material for resiliently engaging other portions of the seal 100. The seal core 116 may be generally rectangular in cross-sectional shape and may have an inner face configured for frictionally engaging the outer face of the shaft surrounding element 108. For example, the seal core 116 may have an inner diameter slightly smaller than the outer face of the shaft surrounding element 108 such that the inner diameter of the seal core 116 may elastically increase when sleeved over the shaft surrounding element 108. The seal core 116 may be reinforced as shown with a reinforcing member 118. The reinforcing member 118 may be configured to maintain the shape of the seal core 116, for example, when the seal core 116 is seated over the shaft surrounding element 108 and against the inner face of the radially extending flange 110. In the embodiment shown, the reinforcing member 118 may include a hoop 120 configured to control the variability of the inner diameter of the seal core 116. That is, as the seal core 116 is sleeved over the shaft surrounding element 108, the inner diameter of the seal core 116 may elastically increase to receive the shaft surrounding element 108, but the increase in the diameter increase may be limited by the diameter of the hoop 120 thereby causing the inner face of the seal core 116 to frictionally engage the shaft surrounding element 108. The reinforcing member may also include a return flange 122 controlling the shape of the seal core 116 and preventing warping or twisting as the seal core 116 is stretched over the shaft surrounding element 68. The return flange 122 may extend radially outward away from the hoop 120 and generally parallel to the radially extending flange 110.

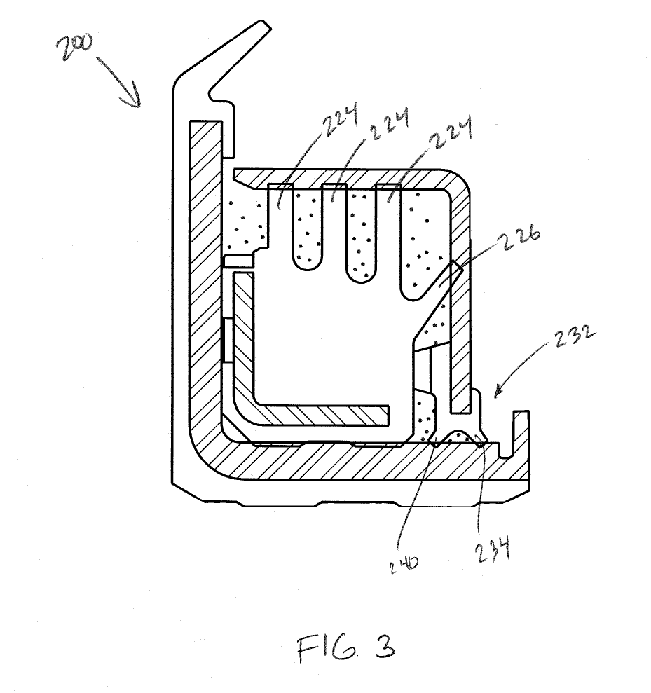

The seal core 116 may include a sealing projection or, as shown, a plurality of sealing projections may be provided. In FIG. 2, for example two radially outward extending sealing projections 124 are shown. In other embodiments, as shown in FIG. 3, three radially outward extending sealing projections 224 are shown. Other numbers of outward extending sealing projections 124 may be provided.

The radially outward extending sealing projections 124 may be configured mainly to prevent or minimize the passage of dirt or debris between the shaft engaging portion 108 of the seal 100 and the housing engaging portion 104. The radially outward extending projections 124 may extend away from the seal core 116 generally parallel to the radially extending flange 110 forming a generally annular shape about the shaft 50. The radially outward extending projections 124 may have a length defining an outer diameter that is slightly greater than an inner diameter of an opposing portion of the housing engaging portion 104 of the seal 100. As such, the tips of the sealing projections 124 may compress elastically and/or bend when the housing engaging portion 104 is sleeved over them. The radially extending projections 124 may thus frictionally engage the housing engaging portion 104 thereby allowing relative rotation of the housing engaging portion 104 relative to the shaft engaging portion 102, while maintaining a sealed condition and preventing passage of dirt and/or debris toward the lubrication chamber 56.

The seal core 116 may further include an additional inner sealing projection 126 extending generally radially outward from the seal core 116 and directed axially inward toward the lubrication chamber 56. The inner projection 126 may, thus, form a generally conical shape about the shaft 50. The inner projection 126 may have a length and angle relative to the radially extending flange 110 such that it frictionally engages a returning portion of the housing engaging portion 104. As such, the inner projection 126 may compress and bend elastically when the housing engaging portion 104 is sleeved over the seal core 116. Like the outward extending sealing projections 124, the inner sealing projection 126 may, thus, frictionally engage the housing engaging portion 104 allowing relative rotation of the housing engaging portion 104 relative to the shaft engaging portion 102, while maintaining a sealed condition and preventing passage of dirt and/or debris toward the lubrication chamber 56.

While not shown, each of the radially extending sealing projections 124 and the inner sealing projections 126 may be provided with a flex section at a point along its length. The flex section may include a necked down or narrowed thickness allowing more flexibility in the projection allowing the projection to more readily accommodate relative axial displacement between the shaft engaging portion 102 and the housing engaging portion 104.

The housing engaging portion 104 may include a boundary element 128 that is substantially plate like in cross-section and substantially cylindrical about the shaft 50. The boundary element 128 may have an outer diameter substantially equal to or slightly greater than a cylindrical opening in the housing 52 such that the housing engaging portion 104 may be frictionally seated in the housing opening. The boundary element 128 may include an axial outer edge and an axial inner edge and an inside plate 130 may extend from the axial inner edge. The inside plate 130 may extend radially inward from the boundary element 128 and may terminate at an inner edge short of the shaft surrounding element 108 defining a gap therebetween. A lubrication seal 132 may be arranged on the inner edge of the inside plate 130 and may be configured to engage the shaft surrounding element 108 and to prevent escape of lubrication from the lubrication chamber 56. A primary portion 134 of the lubrication seal 132 may extend radially inward and axially inward from the inner edge of the inside plate 130 and may include a flex break 136 and a sealing foot 138. The sealing foot 138 may engage the outer surface of the shaft surrounding element 108 and the flex break 136 may allow the sealing foot 138 to flexibly deflect as the relative position of the shaft engaging portion 102 and the housing engaging portion 104 changes or varies. A secondary portion 140 of the lubrication seal 132 may include a seal projection that extends radially inward and axially outward to engage the outer surface of the shaft surrounding portion 108. In other embodiments, as shown in FIG. 3 for example, the primary portion 234 of the lubrication seal 232 may include a seal projection in lieu of the sealing foot with the flex break.

The presently described seal 100 may be particularly adapted to maintain its geometry and, in particular, the relative position of the housing engaging portion 104 and the shaft engaging portion 102. In order to understand the features configured for this, a short discussion of both the assembly and the installation of the seal 100 may be provided.

The seal 100 may be assembled at a factory by the manufacturer, for example. When assembling the seal 100, the seal core 116 may be sleevably engaged with the housing engaging portion 104 of the seal 100. Next, this assembly (i.e., 104/116) may be sleeved over the shaft surrounding portion 108 and pressed against the inner surface of the radially extending flange 110. It is to be appreciated that where keeper lip 109 is provided on the seal 100, it may be formed by the manufacturer later in the process and after the housing engaging portion 104 is assembled with the shaft engaging portion 102 such that the keeper lip 109 does not interfere when the seal core 116 (together with the housing engaging portion 104) is sleeved over the shaft surrounding portion 108. As the assembly (116/104) is pressed over the shaft surrounding portion 108, the frictional engagement of the inner surface of the seal core 116 with the outer surface of the shaft surrounding element 108 may create resistance to such motion. As pressure is placed on the inside plate 130 to urge the assembly over the shaft surrounding portion 108, a tendency to crush the inner sealing projection 126 may occur. However, a bump stop 142 may be provided on the axially outer face of the lubrication seal 132 to limit the distance over which the housing engaging portion 104 may be sleeved over the seal core 116 and, thus, resist or prevent excessive relative motion between the housing engaging portion and the seal core. As such, the described crushing may be reduced or prevented.

The described bump stop 142, in addition to other bump stops, may be advantageous during installation in addition to the above-described assembly. In contrast to assembly, which may be performed by the manufacturer, installation of the seal may typically be performed by a purchaser of the seal such as a farmer, equipment owner, or a service person hired for such installation. The installation may occur onsite on a farm and potentially in a field, for example, which can present a relatively unclean environment causing potential for the seal to encounter dirt, grime, or other debris. It is to be appreciated that the unified seal created by the presence of the keeper lip 109 may be advantageous in this setting to prevent the seal 100 from separating and collecting dirt or debris that may cause the seal to wear out prematurely or may cause dirt and debris to enter the chamber more quickly causing the bearing or other elements to wear out prematurely.

Returning to the bump stop advantages, installation of the seal 100 may create an additional situation where inner portions of the seal could be damaged and prevent suitable performance of the seal 100. When the seal 100 is installed, the installer may put axially inward pressure on the radially extending flange 110. As the seal 100 is seated in the housing 52, the boundary element 128 may frictionally engage the housing 52 causing the housing engaging portion 104 to resist the motion. Accordingly, a tendency for the housing engaging portion 104 to stop moving together with the installation force may cause the radially extending sealing projections 124 to lay to their side and may cause the inner sealing projection 126 to be crushed. In an effort to prevent this deformation of the sealing projections 124, 126, the bump stop 142 previously described on the lubrication seal 132 may help to prevent too much relative motion between the parts. An additional bump stop 144 on an axially outward surface of the seal core 116 may further prevent relative axial displacement between the shaft engaging portion 102 and the housing engaging portion 104. As such, both the assembly forces and installation forces may be accommodated to maintain the integrity of the seal 100.

Although the invention has been described with reference to various embodiments, persons skilled in the art will recognize that changes may be made in form and detail without departing from the spirit and scope of the invention.

What is claimed is:

1. A seal for sealing around a shaft passing through an opening in a housing and into a chamber within the housing, the seal comprising:
a shaft engaging portion;
a housing engaging portion; and
a sealing core arranged between the housing engaging portion and the shaft engaging portion and comprising a plurality of radially outward extending sealing projections configured to sealingly and slidingly engage the housing engaging portion.

2. The seal of claim 1, wherein the shaft engaging portion comprises a radially extending flange configured to cover the opening in the housing.

3. The seal of claim 2, wherein the radially extending flange includes a covering extending radially beyond a radially outward tip of the flange and forming a flap configured to engage the housing and resist entry of wrappage.

4. The seal of claim 3, wherein the covering includes a wraparound portion for controlling the proximity of the radially extending flange to the housing and resisting overstress of the flap.

5. The seal of claim 3, wherein the covering secludes an entirety of an axial facing outer surface of the radially extending flange and seals against the housing and against the shaft, thereby resisting moisture from accessing the radially extending flange.

6. The seal of claim 2, further comprising a unitized design.

7. The seal of claim 6, wherein the unitized design is provided by a keeper lip formed on an axially inner edge of the shaft engaging portion.

8. The seal of claim 2, wherein the plurality of radially outward extending sealing projections comprises two projections.

9. The seal of claim 8, wherein the plurality of radially outward extending sealing projections comprises three projections.

10. The seal of claim 1, wherein the housing engaging portion comprises an axially resistant bump stop to resist excessive relative axial motion between the housing engaging portion and the sealing core.

11. The seal of claim 10, wherein the sealing core comprises an axially resistant bump stop to resist excessive relative axial motion between the shaft engaging portion and the sealing core.

12. The seal of claim 1, further comprising an inner sealing projection extending generally radially outward from the sealing core and directed axially inward toward the chamber.

13. The seal of claim 1, wherein the housing engaging portion comprises a lubrication seal configured to engage the shaft surrounding element and resist escape of lubrication from the chamber.

14. The seal of claim 13, wherein the lubrication seal includes a sealing foot.

15. The seal of claim 14, wherein the lubrication seal includes a flex break configured to accommodate relative radial motion of the housing engaging portion and the shaft engaging portion.

16. The seal of claim 15, wherein the lubrication seal includes a secondary portion in the form of a sealing projection.

17. The seal of claim 13, wherein the lubrication seal includes a primary and secondary sealing projection.

18. A seal for sealing around a shaft passing through an opening in a housing and into a chamber within the housing, the seal comprising:
a shaft engaging portion including a shaft surrounding element and a radially extending flange having a radially outward tip, the radially extending flange having a covering extending radially beyond the radially outward tip of the flange to form a flap configured to engage the housing;
a sealing core sleevingly arranged about the shaft engaging portion and comprising a plurality of radially outward extending sealing projections; and
a housing engaging portion including a boundary element and an inside plate extending radially inward from the boundary element;
wherein:
the plurality of radially outward extending sealing projections sealingly engage the boundary element; and
the flap functions to resist entry of wrappage behind the radially extending flange.

19. The seal of claim 18, wherein the shaft surrounding portion is substantially cylindrical and is separated from the shaft by a portion of the covering.

20. The seal of claim 18, wherein the housing engaging portion includes a bump stop for resisting excessive relative axial motion between the housing engaging portion and the sealing core.
